(19) United States
(12) Patent Application Publication
(10) Pub. No.: US 2024/0202897 A1
(43) Pub. Date: Jun. 20, 2024

(54) SYSTEM FOR DETECTING DEGRADATION OF PAINT AUTONOMOUSLY APPLIED TO A BUILDING

(71) Applicant: Foreman Technologies Inc., dba PaintJet, Hendersonville, TN (US)

(72) Inventor: Nick Hegeman, Hendersonville, TN (US)

(21) Appl. No.: 18/542,444

(22) Filed: Dec. 15, 2023

Related U.S. Application Data
(60) Provisional application No. 63/432,919, filed on Dec. 15, 2022.

(51) Int. Cl. G06T 7/00; B05B 12/16; G06T 7/12

(52) U.S. Cl. CPC G06T 7/0002; B05B 12/16; G06T 7/12; G06T 2207/20081; G06T 2207/20212; G06T 2207/30184

(57) ABSTRACT

One variation of a method includes, during a first time period, accessing a paint failure prediction model representing relationships between paint attributes and paint failure statuses for each painted area, in a constellation of painted areas, of a first structure; segmenting a second structure into a constellation of target areas; and accessing a target paint efficacy duration for the second structure. The method further includes, for each target area in the constellation of target areas: retrieving a surface quality of the target area; generating a predicted environment exposure condition of the target area; based on the paint failure prediction model, the surface quality, and the predicted environment exposure condition of, calculating a set of ambient condition ranges corresponding to absence of predicted paint failure in the target area prior to the target paint efficacy duration; and compiling sets of ambient condition ranges into a paint specification for the second structure.

### CROSS-REFERENCE TO RELATED APPLICATIONS

This application claims the benefit of U.S. Provisional Application No. 63/432,919, filed on 15 Dec. 2022, which is incorporated in its entirety by this reference.

This application is related to U.S. patent application Ser. No. 18/137,374, filed on 20 Apr. 2023, and U.S. patent application Ser. No. 18/137,376, filed on 20 Apr. 2023, each of which is incorporated in its entirety by this reference.

### TECHNICAL FIELD

This invention relates generally to the field of coating applications and more specifically to a new and useful system for detecting degradation of paint autonomously applied to a building in the field of coating applications.

### BRIEF DESCRIPTION OF THE FIGURES

FIGS. 1A and 1B is a flowchart representation of a method;

FIG. 2 is a flowchart representation of one variation of the method; and

FIGS. 3A, 3B, and 3C is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

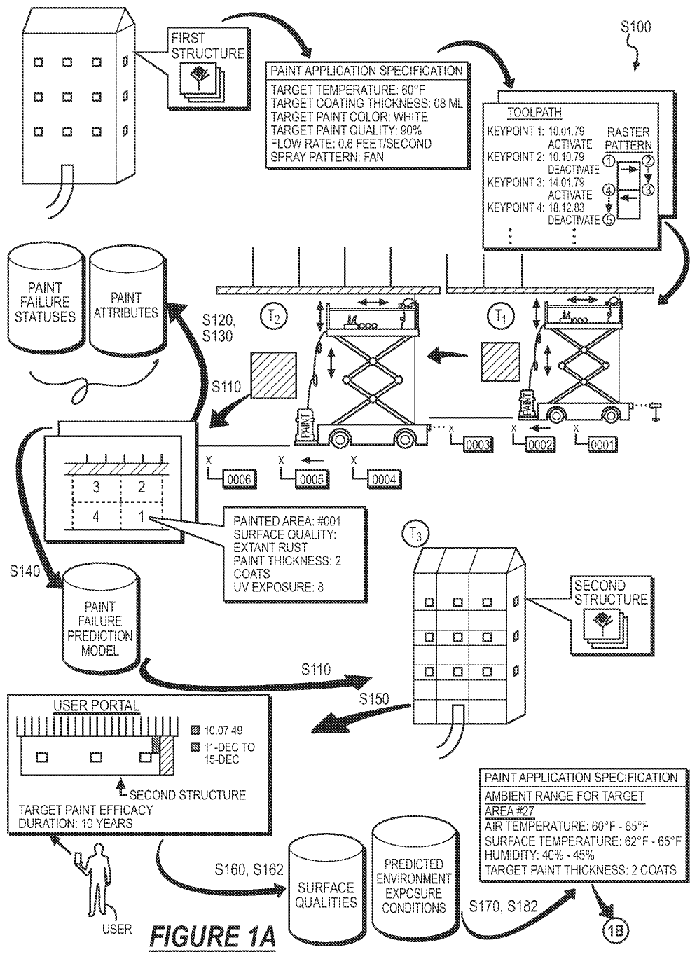

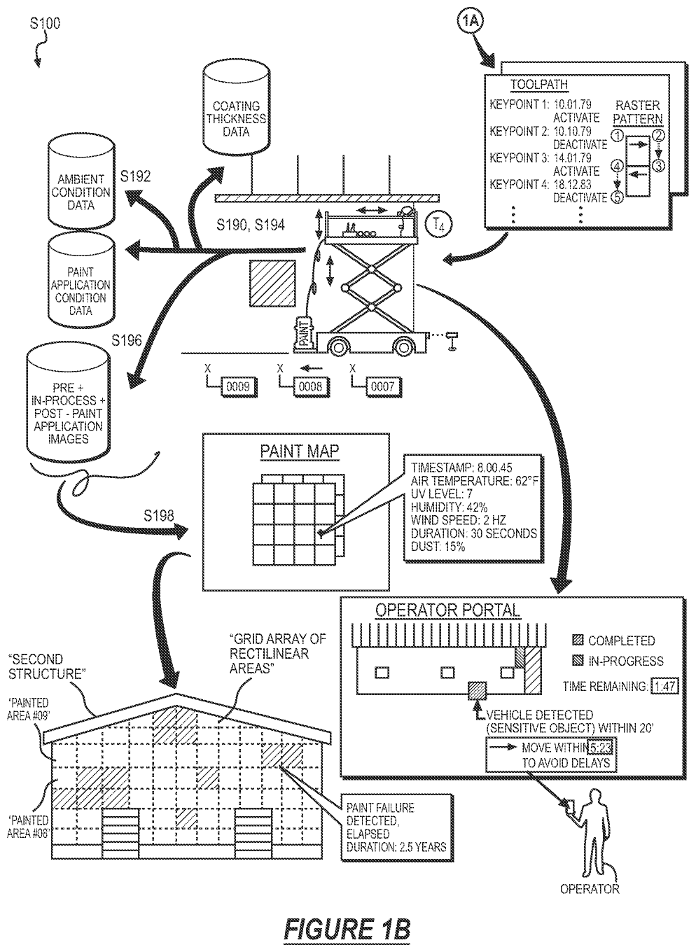

As shown in FIGS. 1A and 1B, a method S100 for detecting degradation of paint includes, during a first time period, segmenting a first structure into a constellation of painted areas in Block S110 and, for each painted area in the constellation of painted areas: accessing a first set of paint attributes for the painted area including a pre-paint surface quality of the painted area prior to paint application onto the painted area, an environment exposure condition of the painted area following paint application onto the painted area, and a set of ambient conditions, proximal the painted area, during paint application onto the painted area in Block S120; and accessing a paint failure status of the painted area, the paint failure status representing one of presence and absence of a detected paint failure in the painted area and responsive to presence of the detected paint failure in the painted area, an elapsed duration from paint application onto the painted area to occurrence of the detected paint failure in the painted area in Block S130. The method S100 further includes, during the first time period, generating a paint failure prediction model representing relationships between sets of paint attributes and paint failure statuses of the constellation of painted areas on the first structure in Block S140.

The method S100 also includes, during a second time period: segmenting a second structure into a constellation of target areas in Block S110; and accessing a target paint efficacy duration for the second structure in Block S150. The method S100 further includes, during the second time period, for each target area in the constellation of target areas: retrieving a surface quality of the target area in Block S160; generating a predicted environment exposure condition of the target area, following paint application onto the target area, for the target paint efficacy duration in Block S162; and, based on the paint failure prediction model, the surface quality of the target area, and the predicted environment exposure condition of the target area, calculating a set of ambient condition ranges corresponding to absence of predicted paint failure in the target area prior to the target paint efficacy duration in Block S170. The method S100 also includes, during the second time period, compiling sets of ambient condition ranges for the constellation of target areas into a paint specification for the second structure in Block S180.

### 2.1 Variation: Likelihood of Paint Failure+Ambient Condition Ranges

One variation of the method S100 includes, during a first time period, segmenting a first structure into a constellation of painted areas in Block S110 and, for each painted area in the constellation of painted areas: accessing a first set of paint attributes for the painted area including a pre-paint surface quality of the painted area prior to paint application onto the painted area, an environment exposure condition of the painted area following paint application onto the painted area, and a set of ambient conditions, proximal the painted area, during paint application onto the painted area in Block S120; and accessing a paint failure status of the painted area, the paint failure status representing one of presence and absence of a detected paint failure in the painted area and, responsive to presence of the detected paint failure in the painted area, an elapsed duration from paint application onto the painted area to occurrence of the detected paint failure in the painted area in Block S130. The method S100 further includes, during the first time period, generating a paint failure prediction model representing relationships between sets of paint attributes and paint failure statuses of the constellation of painted areas on the first structure in Block S140.

This variation of the method S100 further includes, during a second time period: segmenting a second structure into a constellation of target areas in Block S110; and accessing a target paint efficacy duration for the second structure in Block S150. The method S100 further includes, during the second time period, for each target area in the constellation of target areas: retrieving a surface quality of the target area in Block S160; generating a predicted environment exposure condition of the target area, following paint application onto the target area, for the target paint efficacy duration in Block S162; and, based on the paint failure prediction model, the surface quality of the target area and the predicted environment exposure condition of the target area, calculating a set of ambient condition ranges corresponding to likelihood of paint failure in the target area prior to the target paint efficacy duration, less than a threshold likelihood in Block S170. The method S100 also includes, during the second time period, compiling sets of ambient condition ranges for the constellation of target areas into a paint specification for the second structure in Block S180.

### 2.2 Variation: Target Paint Thicknesses

One variation of the method S100 includes, during a first time period, segmenting a first structure into a constellation of painted areas in Block S110 and, for each painted area in the constellation of painted areas: accessing a first set of paint attributes for the painted area in Block S120; accessing a paint thickness of the painted area following paint application onto the painted area in Block S122; and accessing a paint failure status of the painted area, the paint failure status representing one of presence and absence of a detected paint failure in the painted area and responsive to presence of the detected paint failure in the painted area, an elapsed duration from paint application onto the painted area to occurrence of the detected paint failure in the painted area in Block S130. The method S100 further includes, during the first time period, generating a paint failure prediction model representing relationships between sets of paint attributes, paint thicknesses, and paint failure statuses for the constellation of painted areas on the first structure in Block S140.

The method S100 also includes, during a second time period: segmenting a second structure into a constellation of target areas in Block S110; and accessing a target paint efficacy duration for the second structure in Block S150. The method S100 further includes, during the second time period, for each target area in the constellation of target areas: accessing a second set of paint attributes of the target area in Block S164; and, based on the paint failure prediction model and the second set of paint attributes of the target area, calculating a target paint thickness corresponding to absence of predicted paint failure in the target area prior to the target paint efficacy duration in Block S172. The method S100 also includes, during the second time period, compiling target paint thicknesses into a paint specification for the second structure in Block S180.

### 2. Applications

Generally, the computer system and a controller cooperate to: segment a first structure into a constellation of target areas; access satellite or aerial images of a first structure; extract features from these images representing surface conditions of the first structure; generate a surface quality of segments (e.g., one-foot-square areas) of a target surface, such as a contiguous wall, of the structure prior to application of paint onto the target surface based on the features; generate a paint application procedure for the first structure; collect in-process paint application data (e.g., ambient condition data, paint application data, weather data, time interval data) and post-paint application data (e.g., paint thickness, coats of paint, environment exposure conditions); access post-paint application images of the structure; detect presence of paint failures within the paint in (near) real-time based on these post-paint application images; and derive relationships (e.g., correlations, links) between these in-process application data, post-paint application data, and surface qualities for the first structure to generate a paint failure prediction model.

Furthermore, the computer system can: access post-paint application images of the first structure from the controller; extract post-paint application data at the time of completion of the paint application procedure—such as the quantity of paint (e.g., coats of paint, paint thickness) applied to each target surface of the building and presence of defects within the paint—from these images; track these defects over a period of time (e.g., one week, six months, two years, five years); derive correlations between surface qualities of paint and these defects within this period of time; detect a common group of defects occurring on the first structure within this period of time; and calculate an elapsed duration from paint application onto the first structure to the current time of each detected defect in the common group of defects. Then, in response to a first elapsed duration of a first defect exceeding a threshold duration, the computer system can: identify the first defect as a paint failure; detect a failure type of the paint failure; and aggregate the elapsed duration from paint application and the failure type into a paint failure status of a corresponding painted area.

Accordingly, the computer system can define a set of relationships or correspondence between paint attributes defined in the paint map, such as surface qualities, ambient conditions, environment exposure conditions, and/or time interval data, and these paint failure statuses. The computer system can then generate a paint failure prediction model for each painted area, in the constellation of painted areas, of the first structure that links paint attributes and paint failure statuses.

Additionally, the computer system can segment a next structure into a constellation of target areas; access a target paint efficacy duration (e.g., a paint life cycle, a coating warranty duration, a lifetime of the paint) defined by a user within a user portal; access a surface quality of each target area; and generate a predicted environment exposure condition, following paint application onto the target area, for the target paint efficacy duration of each target area. Accordingly, the computer system can: input these surface qualities and predicted environment exposure conditions into the paint failure prediction; and execute the paint failure prediction model to calculate a set of ambient condition ranges corresponding to absence of predicted paint failure in each target area prior to the target paint efficacy duration.

The method S100 is described herein as executed by the computer system to compile data, construct a paint map, flag degradation and predicted paint failures of paint post-paint application; and calculate ambient condition ranges corresponding to absence of predicted paint failure in each target area prior to the target paint efficacy duration for a constellation of target areas on a structure, such as an industrial building or a commercial building. However, the computer system can additionally or alternatively execute Blocks of the method S100 to compile data, construct a paint map, flag degradation and predicted paint failures of the paint post-paint application; and calculate ambient condition ranges corresponding to absence of predicted paint failure in each target area prior to the target paint efficacy duration for a constellation of target areas on a structure, such as a ship hull, an aircraft, manufacturing equipment, port equipment, and/or shipping containers, etc.

### 3. Paint System

A paint system for autonomously applying paint to a structure includes: a chassis including a drive system; a work platform configured to raise and lower on the chassis; a spray system including a set of spray nozzles and a paint supply subsystem configured to selectively supply wet paint from a paint reservoir to the set of spray nozzles; an end effector; an optical sensor; a depth sensor; and a controller. The end effector is mounted to the work platform and is configured to support the set of spray nozzles on the work platform and to direct the set of spray nozzles over a range of positions. The optical sensor is arranged on the work platform and is configured to capture images of a target surface on the structure. The depth sensor is configured to output distance values representative of distances between the set of spray nozzles and a target surface of the structure.

The controller is configured to autonomously: actuate the drive system to navigate the chassis along lateral areas of the target surface; actuate the work platform to navigate the set of spray nozzles vertically within lateral areas of the target surface; actuate the end effector to direct paint, exiting the set of spray nozzles, across lateral areas of the target surface; selectively actuate the spray system to dispense paint from the set of spray nozzles; and selectively deactivate the spray system. The controller is further configured to, for each subregion of the target surface: estimate a coating thickness of paint applied to the subregion of the target surface; and store the coating thickness in association with a location of the subregion on the target surface. The controller is also configured to store an image, captured by the camera and depicting the subregion of the target surface, in association with the subregion of the target surface.

The paint system can interface with a computer system that assembles locations of subregions on the target surface, corresponding non-visual paint application data, and corresponding images captured by the paint system into a paint map that represents paint application across the target surface of the building.

### 3.1 Paint System Components

The paint system for autonomously applying paint to a structure includes: a chassis including a drive system; a work platform configured to raise and lower on the chassis; a spray system including a set of spray nozzles and a paint supply subsystem configured to selectively supply wet paint from a paint reservoir to the set of spray nozzles; an end effector; an optical sensor; a depth sensor; and a controller. The end effector is mounted to the work platform and is configured to support the set of spray nozzles on the work platform and to direct the set of spray nozzles over a range of positions. The optical sensor is arranged on the work platform and is configured to capture images of a target surface or areas of the structure. The depth sensor is configured to output distance values representative of distances between the set of spray nozzles and the target surface.

The controller is configured to autonomously: detect target zones and keepout zones, on the target surface of the structure, proximal the set of spray nozzles based on features detected in images captured by the optical sensor; actuate the drive system to navigate the chassis along lateral areas of the target surface; actuate the work platform to navigate the set of spray nozzles vertically within lateral areas of the target surface; actuate the end effector to direct paint, exiting the set of spray nozzles, across lateral areas of the target surface; selectively actuate the spray system to dispense paint from the set of spray nozzles in response to detecting target zones proximal the set of spray nozzles; and selectively deactivate the spray system in response to detecting keepout zones proximal the set of spray nozzles. The controller is further configured to, for each area of the target surface: estimate a paint thickness of paint applied to the area of the target surface based on paint flow rate through the spray system and actuation speed of the end effector during application of paint onto the area of the target surface; and store the paint thickness in association with a location of the area on the target surface. The controller is also configured to store an image, captured by the camera and depicting the area of the target surface, in association with the area of the target surface.

The system can interface with a computer system that assembles locations of areas on the target surface, corresponding paint thicknesses, and corresponding images captured by the system into a paint map that represents paint application across the target surface of the structure.

### 3.1 End Effector

In one implementation, the end effector includes a linear stage configured to cycle the set of spray nozzles laterally across a target surface of the building. In this implementation, the controller can actuate the single linear stage to cyclically drive the set of spray nozzles laterally across a area (e.g., a four-foot-wide area) of the target surface while intermittently lowering (or raising) the work platform, thereby rastering the set of spray nozzles across the area of the target surface and maintaining the set of spray nozzles substantially normal to the target surface.

In another implementation, the end effector includes a set of linear stages configured to cycle the set of spray nozzles laterally and vertically across the target surface. In this implementation, the controller can actuate the set of linear stages to drive the set of spray nozzles vertically and laterally across an area (e.g., a four-foot-wide, four-foot-tall area) of the target surface, thereby rastering the set of spray nozzles across this area of the target surface and maintaining the set of spray nozzles substantially normal to the target surface. In this implementation, following completion of application of paint onto this area of the target surface, the computer system can trigger the work platform to lower (or rise) to locate the set of spray nozzles in a next area of the target surface.

In the foregoing implementations, the end effector can further include a depth stage configured to drive the set of spray nozzles—and coupled depth sensors—longitudinal substantially normal to the target surface. Accordingly, the controller can: monitor a distance between the set of spray nozzles and the target surface via the depth sensor; and implement closed-loop controls to maintain a target distance between the set of spray nozzles and the target surface by selectively actuating the depth stage of the end effector.

Additionally or alternatively, the end effector can include a set of rotary stages configured to adjust pitch and/or yaw orientations of the set of spray nozzles and coupled depth sensors. In this implementation, the controller can: monitor distances between the set of spray nozzles and a set of (e.g., three or more) laterally- and vertically offset points on an adjacent region of the target surface via the depth sensor; and implement closed-loop controls to adjust the pitch and/or yaw orientations of the end effector and equalize distances to these three points on the adjacent region of the target surface, thereby maintaining the set of spray nozzles normal to the region of the target surface in its spray field.

For example, the end effector can include a multi-axis gantry. Alternatively, the end effector can include a robotic arm including multiple segments and joints.

### 3.2 Optical and Depth Sensors

In one implementation, the system includes a near-field 2D color (e.g., RGB, multispectral) camera: arranged proximal the set of spray nozzles and defining a focal axis approximately parallel to a spray axis of the set of spray nozzles such that the field of view of the color camera intersects a spray field of the set of spray nozzles; and configured to capture 2D color images of the target surface before, during, and/or after the set of spray nozzles applies (i.e., sprays) paint on the adjacent target surface. For example, the system can include: a left color camera arranged to the left of the set of spray nozzles and configured to capture images of the target surface ahead of the set of spray nozzles as the end effector moves the set of spray nozzles leftward; and a right color camera arranged to the right of the set of spray nozzles and configured to capture images of the target surface ahead of the set of spray nozzles as the end effector moves the set of spray nozzles rightward.

Additionally or alternatively, the system can include a near-field 3D stereoscopic camera arranged proximal the set of spray nozzles and configured to capture 3D color images of the target surface. The system can similarly include a near-field multi-point depth sensor (e.g., a set of single-point depth sensors, a 3D LIDAR sensor): arranged proximal the set of spray nozzles and defining a focal axis approximately parallel to the spray axis of the set of spray nozzles; and configured to capture depth values or depth maps representing distances from the set of spray nozzles to points on the target surface in the spray field of the set of spray nozzles.

For example, the depth sensor can be configured to detect: peripheral distances to at least three discrete points—on a nearby surface—offset about a 20-inch-diameter circle centered on the axis of the set of spray nozzles at a distance of twelve-inches from the set of spray nozzles; and a center distance to a discrete point—on the nearby surface—approximately centered on the axis of the set of spray nozzles at a distance of twelve-inches from the set of spray nozzles.

In the foregoing implementations, the system can also include a housing with an actuatable aperture arranged adjacent the set of spray nozzles, such as mounted on or near the end effector. In this implementation, the near-field color, the near-field stereoscopic camera, and/or the depth sensor can be arranged in the housing. Accordingly, the controller can: trigger the aperture to close when the spray system is actuated in order to shield these sensors from overspray; and selectively trigger the aperture to open and these sensors to capture images, depth values, and/or depth maps when the spray system is inactive.

Additionally or alternatively, the system can include a far-field 2D color camera, a far-field 3D stereoscopic camera, and/or a far-field depth sensor, such as: arranged on the work platform; and offset behind the set of spray nozzles (e.g., where these sensors are less subject to overspray).

In the foregoing implementations, the near-field sensors can be arranged on the end effector and thus move with the set of spray nozzles. Alternatively, these near-field sensors can be fixedly mounted to the work platform, and the controller can: derive a position (i.e., offset distance and orientation) of the work platform relative to the target surface based on data captured by these sensors; track a position of the set of spray nozzles relative to the work platform (e.g., by reading position sensors or encoders arranged on actuators or stages in the end effector); and fuse these platform-to-target-surface data positions and platform-to-set of spray nozzles positions to track the position of the set of spray nozzles relative to the nearby target surface.

The far-field optical and depth sensors can be similarly coupled to or decoupled from the end effector and the set of spray nozzles, and the controller can similarly track relative positions of the target surface, these far-field sensors, and the set of spray nozzles.

### 3.4 Other Sensors

In one variation, the paint system further includes: an ambient temperature sensor; an infrared thermometer configured to read a surface temperature of the target surface; a windspeed sensor; an ultraviolet radiation sensor (e.g., a radiometer); and/or a humidity sensor, such as mounted to the work platform proximal the set of spray nozzles.

### 4. Site Plan

During or prior to deployment of the paint system to a work site, the computer system can access data representing a structure, such as a building or a ship aircraft, and generate a set of waypoints defining navigation of the paint system around the structure during a subsequent paint application procedure.

In one implementation, the computer system accesses an aerial or satellite image—such as from an aerial mapping service—of a work site occupied by a structure designated for paint application. In this implementation, the computer system then interfaces with an operator to select a set of target surfaces of the structure for paint application, such as: by enabling the operator to select target surfaces directly from the aerial image; by recording points dropped on the aerial image by the operator and interpolating target surfaces between these points.

In one variation, an operator (or the computer system) deploys an unmanned aerial vehicle to a work site occupied by a building, prior to or with the paint system. The aerial vehicle then executes an autonomous or manually-controlled flight path to navigate around the building while capturing color and/or depth images of the building. The aerial vehicle and/or the computer system then compiles these color and/or depth images into a three-dimensional model of the building and surrounding topography. The computer system then: presents the model of the building to the operator; and interfaces with the operator to select a set of walls of the building for paint application, such as by enabling the operator to select surfaces or define bounded areas (e.g., boxes) on walls represented in the model of the building.

In another variation, for a newly-constructed and completed building erected at the work site, the computer system can access a virtual (e.g., CAD) three-dimensional georeferenced model of the building, such as generated by an engineer on behalf of a site manager. Alternatively, for an in-process building currently under construction at the work site, the computer system can similarly access a virtual (e.g., CAD) three-dimensional georeferenced model of the building. The computer system then: presents this virtual model of the building to the operator; and interfaces with the operator to select a set of walls of the building for paint application, such as by enabling the operator to select surfaces or define bounded areas (e.g., boxes) on walls represented in the model of the building.

In the foregoing variations, the computer system then: scans the model of the building—including surrounding topographical features—for obstacles near the selected walls of the building, such as shrubs, utility boxes, signs, and benches; and defines a system path along the walls selected by the operator, such as nominally offset from these walls by a predefined target system offset distance (e.g., six feet) and that maintains a minimum distance (e.g., two feet) from detected obstacles. The computer system then constructs an ordered sequence of geospatially-referenced keypoints along this system path, such as offset along the paint system path by a target building segment width (e.g., six feet); and uploads these keypoints to the paint system.

Furthermore, the computer system can: extract a height of a selected wall of the building at each building segment; and annotate each keypoint with a height of the corresponding building segment. The paint system can then navigate the work platform and the set of spray nozzles to the height specified in a keypoint when applying paint to the corresponding building segment on the building, as described below.

Alternatively, the paint system can autonomously generate the paint system path and sequence of keypoints in real-time based on data captured by the paint system while applying paint to the building.

### 5. First Structure Segmentation+Site Setup

Generally, the computer system or the controller can divide a first structure into segments representing one-foot-square areas on each target surface of the first structure. The computer system can access pre-paint application images—such as overhead images captured by the aerial vehicle, or images captured by the optical sensor arranged in the paint system prior to paint application—and extract features, representing surface characteristics of the first structure, from these pre-paint application images. The computer system or the controller can then derive a surface quality (e.g., a high quality, a medium quality, a low quality) of each segment (e.g., one-foot-square area) of the first structure based on these features.

In one implementation, the computer system can: access a set of images depicting the first structure and captured by an aerial vehicle; compile a subset of images, in the set of images, into a composite image depicting a contiguous target surface of the first structure; detect a boundary of the contiguous target surface in the composite image; scale a grid array of rectilinear areas to yield target area dimensions on the contiguous target surface; and project the grid array of rectilinear areas onto the composite image within the boundary to define a constellation of target areas on the first structure (e.g., a set of target areas, a population of target areas). Then, for each target area in the constellation of target areas, the computer system can: detect a set of features in a region of the composite image corresponding to the target area; and derive a surface quality of the target area based on the set of features.

In one variation, the computer system can access dimensions of the first structure, defined by a user via the user portal, and derive the grid array of rectilinear areas based on these dimensions. The computer system can then access an overhead image depicting the first structure, such as from a satellite image database or from an aerial vehicle deployed to a location of the first structure, and project the grid array of rectilinear areas onto this overhead image to define a constellation of target areas on the first structure. The computer system can then: extract a set of features representing surface characteristics of the first structure, such as texture, dust, extant paint, rust, algae, or corrosion on each surface of the first structure, and derive a surface quality of each target area based on this set of features.

For example, the computer system can: access a set of aerial images depicting a building and captured by an aerial vehicle; compile a subset of images, in the set of images, into a composite image depicting a wall of the building; detect a boundary of the wall, such as a 10 feet width by 20 feet height, in the composite image; scale a grid array of rectilinear areas to yield target area dimensions, such as one-foot-square-areas, on the wall; and project the grid array of rectilinear areas onto the composite image within the boundary to define the constellation of target areas on the building. Then, for each target area in the constellation of target areas, the computer system can: detect a set of features, representing surface characteristics of the wall, in a region of the composite image corresponding to the target area; and derive a surface quality of the target area based on the set of features.

In another variation, during a scan cycle, the controller can access a set of images captured by the optical sensor arranged in the paint system and compile images into a composite image depicting a contiguous target surface of the first structure. The controller can then implement methods and techniques described above: to project the grid array of rectilinear areas onto the composite image within a boundary to define the constellation of target areas on the first structure; and to derive a surface quality of each target area based on features detected in the composite image.

Once the controller or the computer system segments each target surface of the first structure into a constellation of target areas, the operator may manually deploy the paint system onto the work site, such as by navigating the paint system near a first keypoint along the system path or otherwise near a first corner of the first structure to face a first target zone on a first target area of the first structure and then verify the target zone prior to executing a paint application cycle.

Alternatively, once deployed to the work site, the controller can implement autonomous navigation techniques to navigate the set of spray nozzles toward the first keypoint along the system path and execute a paint application cycle. Furthermore, once the paint system occupies a first keypoint or otherwise faces the first target area, the controller can autonomously drive the work platform upwardly to locate the top edge of a first target area of the first structure within the spray field of the set of spray nozzles and within the field of view of the optical sensor. For example, the paint system can drive the work platform upwardly to locate the set of spray nozzles at a known peak height of the first structure associated with the first target area.

### 5.1 Surface Quality

In one variation, the computer system can access pre-paint application images of the first structure and derive a surface quality of each target area prior to application of paint onto the first structure.

Furthermore, the computer system can: access pre-paint application images of the first structure, captured by the optical sensor, from the controller; access pre-paint application images from an aerial vehicle sent to capture images of the first structure prior to commencement of the paint application procedure; and/or access a set of satellite images depicting the first structure from a satellite mapping database. The computer system can then extract features from these pre-paint application images and derive a surface quality (e.g., high quality, medium quality, low quality) of each target area of the first structure based on these features. The computer system can then calculate a quantity of paint (e.g., coats of paint, paint thickness) to apply to each target area of the first structure based on these surface qualities.

For example, the computer system can: access a set of satellite images prior to paint application depicting a target surface of a first structure; extract a set of features representing surface characteristics—such as texture, dust, extant paint, rust, corrosion, algae, etc.—of the first structure from the set of satellite images; derive a first surface quality, such as a low quality, of a first target area of the first structure based on the features; and calculate a target paint thickness, such as three coats, to apply to the first target area according to the first surface quality. The computer system can then repeat these methods and techniques for each other target area of the first structure and compile these quantities of paint and surface qualities to generate a paint application procedure for the first structure and transmit the paint application procedure to the controller for execution.

### 6. First Structure+Paint Application Data

Generally, the controller and the computer system cooperate to capture visual and non-visual paint application data across areas of the first structure and to compile these data into a paint map.

More specifically, during the scan cycle, the computer system (or the controller) implements methods and techniques described above to segment the first structure into a constellation of target areas and derive a surface quality of each target area. The controller can further: access pre-paint application images captured by the optical sensor in the paint system; access a spray pattern of a spray nozzle coupled to the spray system; detect ambient conditions of each target area during paint application via ambient sensors (e.g., ambient air temperature, ambient surface temperature, ambient humidity of air, ambient wind speed, ambient ultraviolet radiation); access post-paint application images of each target area post-paint application captured by the optical sensor; and calculate a time interval associated with application of paint onto each target area. The computer system can receive these visual and non-visual data from the controller and derive an environment exposure condition of each target area post-paint application (e.g., mild, moderate, severe, very severe, or extreme exposure). The computer system can further assemble pre-paint application images, post-paint application images, surface qualities, ambient conditions, time intervals, and environment exposure conditions into a paint map of the first structure.

In one implementation, during a paint application cycle, the controller can: detect a first set of ambient conditions of a first target area; navigate the spray system along a toolpath to apply a volume of paint from the spray nozzle over the first target area of the first structure; predict a first paint thickness of the volume of paint on the first target area based on the spray pattern; and capture a sequence of post-paint application images depicting the first volume of paint on the first target area. The computer system can then: access a weather condition database; track a set of weather conditions associated with the first structure during a future time period (e.g., one day, one week, or one month from paint application); and derive a first environment exposure condition of the first target area based on the first surface quality and a combination of the set of weather conditions. The computer system can then aggregate the pre-paint application images, the post-paint application images, the first surface quality, the first set of ambient conditions, the first paint thickness, and the first environment exposure condition into a paint map of the first structure.

### 6.1 Paint Map

In one implementation, during the paint application cycle, the computer system (or the controller) can: initialize a paint map of the first structure, such as in the form of a three-dimensional surface model of the first structure or a set of two-dimensional surfaces of each side of the first structure; and assemble color and/or depth images captured by the paint system during the paint application procedure into visual pre-paint application, in-process, and/or post-paint application layers within the paint map, as shown in FIG. 1B.

In one variation, during the paint application procedure, the controller can capture pre-paint application images, such as: far-field images of a subregion of the building segment prior to applying paint across the subregion of the building segment; near-field images of the subregion of the building segment while the work platform rasters the near-field camera across the subregion of the building segment prior to applying paint to the surface; and/or near-field images captured by the left near-field camera while the work platform moves the set of spray nozzles leftward across the subregion of the building segment and near-field images captured by the right near-field camera while the work platform moves the set of spray nozzles rightward across the subregion of the building segment during application of paint onto the target surface. The computer system can then: access these pre-paint application images; extract features from these pre-paint application images representing surface conditions of the target surface; and detect and characterize a surface quality of the target surface based on the features.

In another variation, the controller can capture in-process images including: near-field images captured by the left near-field camera while the work platform moves the set of spray nozzles rightward across the subregion of the building segment and near-field images captured by the right near-field camera while the work platform moves the set of spray nozzles leftward across the subregion of the building segment during application of paint onto the target surface. The computer system can then: access these in-process paint application images representing conditions of the target surface; extract features from these images representing characteristics of the paint; detect a thickness of the paint based on the features; and receive in-process non-visual paint application data from the controller.

In yet another variation, the controller can capture post-paint application images including: far-field images of the subregion of the building segment after applying paint across the subregion of the building segment; near-field images of the subregion of the building segment while the work platform rasters the near-field camera across the subregion of the building segment after completion application of paint across the subregion of the building segment; and/or near-field images captured by the left near-field camera while the work platform moves the set of spray nozzles rightward across the subregion of the building segment and near-field images captured by the right near-field camera while the work platform moves the set of spray nozzles leftward across the subregion of the building segment during application of paint onto the target surface. The computer system can then: access these post-paint application images; extract features from these post-paint application images representing characteristics of the paint; and receive post-paint application non-visual paint application data from the controller.

Accordingly, the computer system (or the controller) can: stitch these pre-paint application images into a composite (e.g., panoramic) pre-paint application image of the first structure and store this composite pre-paint application image in a pre-paint application layer of the paint map; stitch these in-process images into a composite (e.g., panoramic) in-process image of the first structure and store this composite in-process image in an in-process layer of the paint map; and/or stitch the post-paint application images into a composite (e.g., panoramic) post-paint application image of the first structure and store this composite post-paint application image in a pre-paint application layer of the paint map.

### 6.1.1 First Structure Visual Representation

In the variation described above in which the paint system captures depth maps of the first structure via the depth sensor, the computer system can further assemble these depth maps into a three-dimensional model of the first structure.

Alternatively, in the variation described in which the computer system accesses a three-dimensional model of the first structure, such as based on data captured by an aerial vehicle deployed to the work site, the computer system can: overlay the foregoing pre-paint application, in-process, and post-paint application layers onto the first structure visual representation; and enable the operator to virtually navigate between regions of the first structure visual representation and selectively activate these layers to view pre-paint application, in-process, and post-paint application images of these first structure regions.

Additionally, in this variation, the computer system can: link individual pixels in the first structure visual representation to sets of post-paint application color images that depict areas on the first structure corresponding to these individual pixels; store this annotated first structure visual representation as the paint map; and enable the operator to virtually navigate between regions of the first structure visual representation and select individual pixels within the first structure visual representation to access pre-paint application, in-process, and/or post-paint application images of corresponding areas of the first structure. The computer system can further represent the constellation of target areas of the first structure in the pre-paint application layer and the in-process application layer within the paint map. The computer system can then represent the constellation of target areas as a constellation of painted areas of the first structure in the post-paint application layer of the paint map.

### 6.2 Ambient Condition Data

Generally, during application of paint onto the constellation of target areas of the first structure, the controller can sample and record surface temperatures orientations, ambient temperature of air, ambient humidity of air, ambient dust exposure, and/or wind speed, such as at a rate of 2 Hz, proximal each target area of the first structure. Accordingly, the computer system and/or the controller can annotate the paint map with these ambient condition data.

In one implementation, the controller: implements dead reckoning, structure from motion, visual odometry, and/or other techniques to track the field of view of the infrared thermometer across the constellation of target areas of the first structure; reads surface temperatures across the constellation of target areas—such as prior to application of paint—from the infrared thermometer; and stores surface temperature readings with concurrent positions of each target area in the constellation of target areas. The computer system (or the controller) can then annotate discrete positions within the paint map with their corresponding surface temperatures prior to application of paint onto the constellation of target areas, such as in real-time.

For example, the controller can: detect ambient conditions of each target area of the first structure via sensors arranged in the paint system and then aggregate these ambient conditions into the paint map. During a first paint application cycle, the controller can: detect a first ambient temperature of air proximal a first target area of the first structure; detect a first ambient surface temperature of the first target area; and record a first ambient humidity condition of air proximal the first target area. During a second paint application cycle, the controller can: detect a second ambient temperature of air proximal a second target area of the first structure; detect a second ambient surface temperature of the second target area; and record a second ambient humidity condition of air proximal the second target area. Then, the controller can aggregate the first ambient temperature of air, the first ambient surface temperature, the second ambient temperature of air, the second ambient surface temperature, the first ambient humidity condition, and the second ambient humidity condition into the paint map. The controller can annotate the corresponding area of the first structure within the paint map with these ambient conditions during each paint application cycle in real-time.

The controller can repeat these methods and techniques for each other target area in the constellation of target areas of the first structure to aggregate current ambient conditions into the paint map and update the paint map of the first structure with these current ambient conditions in real-time.

Additionally or alternatively, the controller and the computer system can cooperate to annotate discrete positions within the paint map with ambient condition data (e.g., air temperature, humidity, wind speed, dust exposure) read from the sensors of the paint system when the spray field of the set of spray nozzles intersects corresponding positions on the first structure. For example, when configured to raster the set of spray nozzles—defining a one-inch-wide and twelve-inch-tall spray field—across the first structure at a rate of two feet per second with 50% overlap between horizontal raster legs, and when the configured to sample these sensors at 2 Hz, the computer system (or the controller) can annotate each discrete region of the paint map that represents discrete six-inch-tall, twelve-inch wide target areas of the first structure with corresponding ambient and surface values.

However, the controller and the computer system can cooperate to capture and store ambient condition data in any other resolution within the paint map.

### 6.3 Paint Application Data: Time Interval Data

Similarly, during application of paint onto the first structure (e.g., in-process paint application), the controller can: record non-visual paint application data; derive time intervals of the paint application procedure based on these data, such as an interval of time between initiation of paint application and commencement of paint application onto each target area; and annotate corresponding regions of the paint map with these derived time intervals of the paint application procedure.

In one implementation, the controller can access images from sensors of the paint system throughout the time interval of the paint application procedure to collect an initial timestamp corresponding to initiation of the paint application procedure and derive time intervals for the paint application procedure for each region of the paint map relative to the initial timestamp. The computer system (or the controller) can then annotate discrete regions within the paint map, representing painted areas of the first structure, with their corresponding time interval for the paint application procedure relative to the initial timestamp.

For example, the controller can: access a set of images from the optical sensor of the paint system and annotated with timestamps; collect an initial timestamp, such as 08.00.15, corresponding to the initiation of the paint application procedure from an initial image in the set of images; derive a first time interval of the paint application procedure for a first region within the paint map, such as 30 seconds, corresponding to a first painted area of the first structure, relative to the initial timestamp, such as 08.00.45; derive a second time interval of the paint application procedure for a second region within the paint map, corresponding to a second painted area, relative to the initial timestamp, such as 08.01.15; derive a third time interval of the paint application procedure for a third region within the paint map, corresponding to a third painted area, relative to the initial timestamp, such as 08.01.45; and annotate each discrete region within the paint map with corresponding time intervals of paint application onto the first structure.

6.4 Real-Time v. Post-Hoc Paint Map

In one implementation, the controller: executes the foregoing methods and techniques to capture paint application, ambient condition data, and surface data for the first structure while autonomously applying paint to the first structure; and offloads (e.g., streams) these data to the computer system, such as during or following completion of this paint application procedure. The computer system then executes the foregoing methods and techniques to generate the paint map following completion of the paint application procedure.

In one variation, the controller (or the computer system) can execute this process in real-time to generate and develop the paint map during this paint application onto the first structure. In this variation, the controller (or the computer system) can selectively pause paint application onto the first structure, generate an inspection prompt, and serve this inspection prompt to the operator in near real-time, such as in response to: estimated applied paint thicknesses deviating from target paint thicknesses; surface temperatures on the first structure falling outside of a target surface temperature range defined in the paint specification; ambient air temperatures of air proximal target areas of the first structure falling outside of a target ambient air temperature range defined in the paint specification; ambient humidity of air proximal target areas of the first structure falling outside of a target ambient humidity range defined in the paint specification and/or local wind speeds exceeding a threshold wind speed.

For example, the controller (or the computer system) can serve a prompt to the operator in near real-time in response to such conditions and only resume paint application according to the paint specification once confirmed by the operator.

### 7. Paint Failure Prediction Modeling

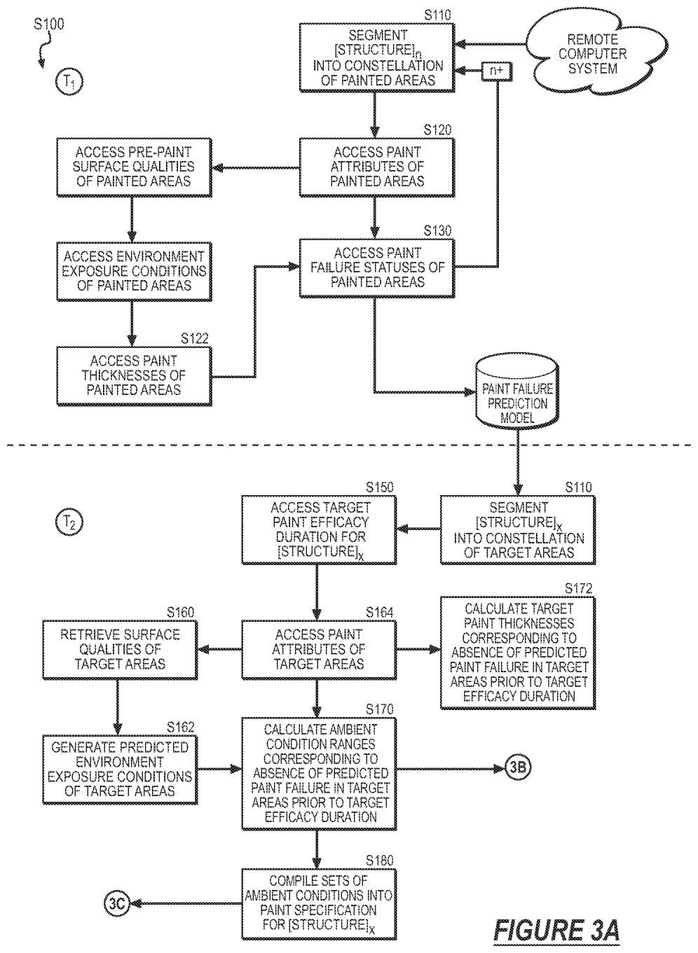

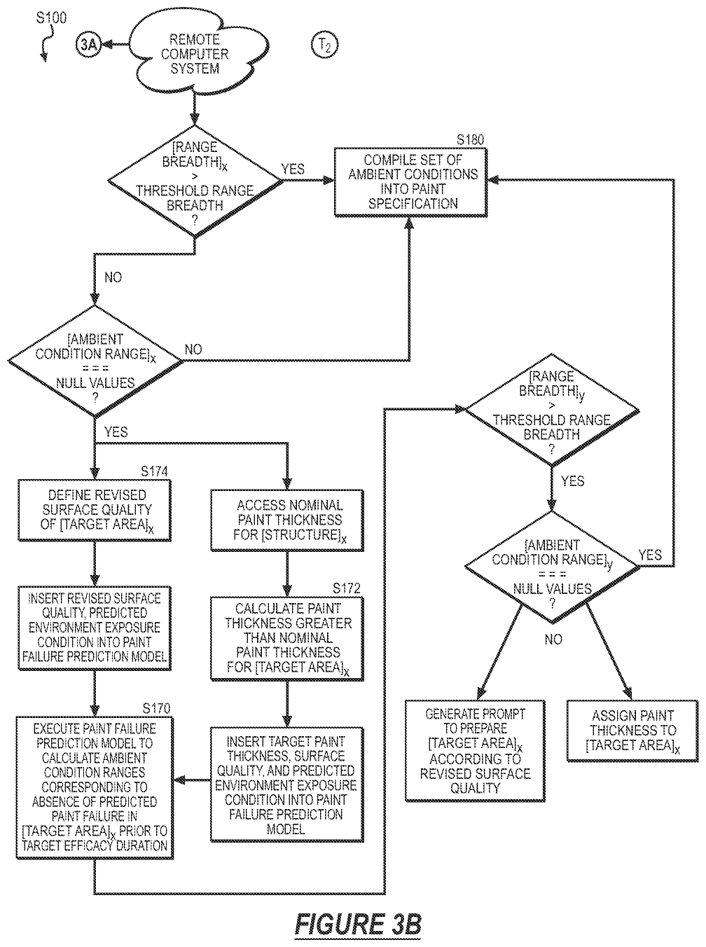

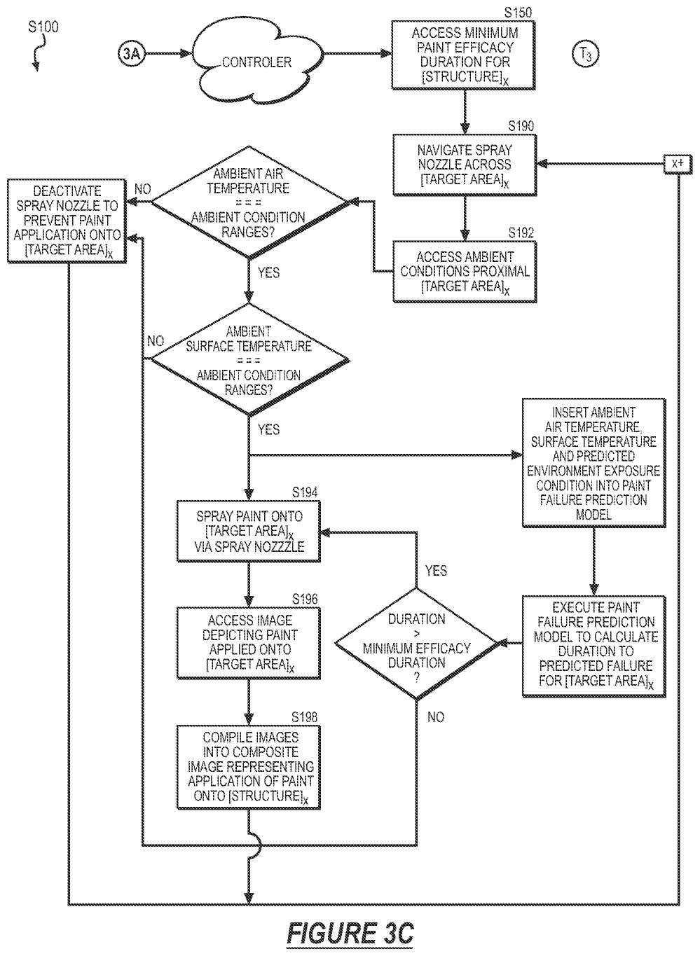

Generally, the computer system can periodically deploy the aerial vehicle to the worksite of the first structure to capture post-paint application images, such as upon completion of the paint application procedure, one week after completion, six months after completion, or one year after completion. The computer system can then access these post-paint application images and execute Blocks of the method S100 to segment the first structure into a constellation of painted areas. The computer system can further access the paint map and extract paint attributes associated with the first structure including surface quality data, ambient condition data, paint thicknesses, and environment exposure conditions for the constellation of painted areas, as shown in FIG. 3A.

More specifically, the computer system can: access post-paint application images depicting the first structure; segment the first structure into a constellation of painted areas corresponding to target areas defined in the paint map based on these post-paint application images; extract post-paint application data from these post-paint application images; and derive correlations between these post-paint application images, surface qualities, and ambient condition data of the constellation of painted areas defined in the paint map to derive paint failure statuses of each painted area of the first structure.

In one implementation, the computer system can: access post-paint application images of the first structure from the controller; extract post-paint application data at the time of completion of the paint application procedure—such as the quantity of paint (e.g., coats of paint, paint thickness) applied to each target surface of the building and presence of defects within the paint—from these images; track these defects over a period of time (e.g., one week, six months, two years, five years); derive correlations between surface qualities of paint and these defects within this period of time; detect a common group of defects occurring on the first structure within this period of time; and calculate an elapsed duration from paint application onto the first structure to the current time of each detected defect in the common group of defects. Then, in response to a first elapsed duration of a first defect exceeding a threshold duration, the computer system can: identify the first defect as a paint failure; detect a failure type of the paint failure; and aggregate the elapsed duration from paint application and the failure type into a paint failure status of a corresponding painted area.

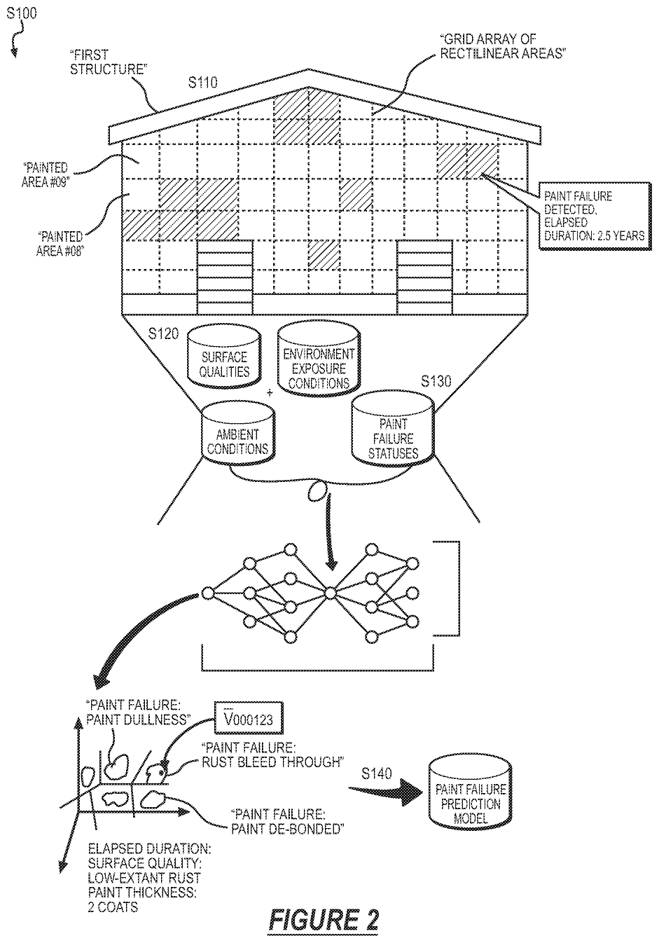

Accordingly, the computer system can define a set of relationships or correspondence between paint attributes defined in the paint map, such as surface qualities, ambient conditions, environment exposure conditions, and/or time interval data, and these paint failure statuses. The computer system can then generate a paint failure prediction model for each painted area, in the constellation of painted areas, of the first structure that links paint attributes and paint failure statuses of each painted area, as shown in FIG. 2.

In particular, the computer system can: detect a group of common defects—such as rust bleeding through paint associated with a low quantity of paint, paint flaking associated with a medium quantity of paint, paint sagging (e.g., running) associated with a high quantity of paint—repeating at a high frequency of occurrence during a particular time period (e.g., one year); track the frequency of the group of common defects during future time periods of paint application procedures for other structures; define a set of relationships between quantity of paint, surface quality, ambient conditions, environment exposure conditions, and paint failure statuses based on the frequency of the common group of defects detected during future time periods; and generate a paint failure prediction model—that links surface quality, quantity of paint, ambient conditions, environment exposure conditions, and paint failures results—based on the pattern of the group of common defects.

Alternatively, the computer system can implement these methods and techniques to access post-paint application images of each painted area of a first structure periodically (e.g., completion of paint application procedure, one week after completion, six months after completion), extract post-paint application data from these post-paint images, and derive relationships between these paint attributes and paint failure statuses of the first structure to further train the paint failure prediction model.

Therefore, the computer system can access paint attributes of the first structure, detect paint failure statuses of the first structure over a period of time, and then derive paint failure predictions models linking these paint attributes and paint failure statuses for each painted area of the constellation of painted areas. Additionally, the computer system can input paint attributes of other structures into the paint failure prediction model to calculate ambient condition ranges to reduce paint failure in a target area of this structure prior to a target paint efficacy duration (e.g., a life cycle duration of paint, a warranty of paint), as further described below.

### 8. Second Structure+Paint Specification

Generally, the computer system can access overhead images, depicting a second structure, captured by the aerial vehicle and implement methods and techniques described above to segment the second structure into a constellation of target areas, derive surface qualities of the second structure, and generate predicted environment exposure conditions. The computer system can then access a target paint efficacy duration (e.g., a warranty duration, a life cycle duration) specified for paint application onto the second structure, such as defined by a user associated with the second structure or autonomously defined by the computer system. The computer system can further input these surface qualities and predicted environment exposure conditions into the paint failure prediction model and execute the paint failure prediction model to converge on a set of ambient condition ranges corresponding to absence of predicted paint failure in each target area prior to the target paint efficacy duration.

In one implementation, the computer system: accesses a target paint efficacy duration—defined by the user within the user portal or autonomously defined by the computer system—for the second structure; derives a surface quality of each target area and stores these surface qualities in a surface quality database associated with the second structure; and estimates an environment exposure condition for each target area. Then, based on the paint failure prediction model, the known surface qualities, and the predicted environment exposure conditions, the computer system: calculates a set of ambient condition ranges and/or calculates a target paint thickness corresponding to absence of paint failure in each target area prior to the target paint efficacy duration. The computer system compiles these ambient condition ranges and target paint thicknesses for the constellation of target areas into a paint specification for the second structure and transmits this paint specification to the controller for execution by the paint system.

### 8.1 Manual Target Paint Efficacy Duration+Environment Exposure Condition

In one variation, the computer system can receive selection of a target paint efficacy duration defined by a user associated with the second structure within the user portal. Furthermore, the computer system can: interface with the user portal to define a location of a worksite occupied by the second structure; define a time window for paint application onto the second structure; and select priorities of interest to the user for the target paint efficacy duration of paint applied to the second structure from a menu of predefined priorities (e.g., a list, a table, or a questionnaire of priorities). The computer system can then access the location, the time window, and the priorities for the second structure and generate predicted environment exposure conditions for the constellation of target areas of the second structure.

Furthermore, the computer system can display a menu of predefined priorities associated with a target paint efficacy duration for a paint application. In particular, the computer system can display a menu of predefined priorities including: a first priority for a minimum target paint efficacy duration; a second priority for a maximum target paint efficacy duration; a third priority for paint application within the time window; etc. The user may then select the priorities of interest to the user for the second structure.

For example, a manager may request paint application of a building within the user portal. The manager may define a location of a worksite occupied by the building, define a time window, such as between Dec. 11, 2023 and Dec. 15, 2023, for paint application onto the building. The manager may then review a menu of predefined priorities and select a priority indicating a maximum target paint efficacy duration for paint applied to the building. The computer system can access the location, the time window, and the priority for the building and access a set of environment conditions within the time window from an environment condition database, such as an ultraviolet radiation index or a rain percentage during the time window. The computer system can then: calculate an average ultraviolet index and an average rain percentage for each date in this time window and define a first predicted environment exposure condition, such as mild, for each target area of the building.

Alternatively, the computer system can: access a location and an orientation of each painted area on the first structure; receive selection of a time window for paint application onto the second structure; access historical weather condition data for similar time windows in the past; based on locations and orientations of the constellation of painted areas and historical weather conditions for time windows analogous to the first time window, access a set of weather conditions within the first time window for a particular target area; and, based on the set of weather conditions, generate a predicted environment exposure condition for this particular target area.

Thus, the computer system can interface with the user portal to receive priorities of interest to the user, a location of a worksite and structure, and a target time window as a paint application request for the structure. Additionally, the computer system can receive selection of a target paint efficacy duration defined by the user.

### 8.1.1 Semi-Autonomous Target Paint Efficacy Duration

In one variation, the computer system can present a detected paint failure to an operator associated with the paint system. Responsive to the operator's indication that the paint failure is present, the computer system can: reinforce the paint failure detection model; calculate a time interval between the initial timestamp of the paint application of a painted area and the timestamp of the detected paint failure; and derive a target paint efficacy duration for this type of paint failure based on the time interval.

Furthermore, the computer system can generate a safety factor, such as 1.5 or 2, to incorporate paint application data deviations (e.g., difference between measured ambient and surface data versus actual ambient and surface data). The computer system can then derive a target paint efficacy duration for each failure type based on a combination of each time interval and each safety factor. For example, the computer system can: calculate a time interval, such as 10 years, between the initial timestamp of the paint application to a painted area and the timestamp of the detected paint failure; access a safety factor associated with this failure type; derive a target paint efficacy duration, such as 15 years, for a paint flaking failure type based on a combination of the time interval and the corresponding safety factor, such as 1.5; and present the target paint efficacy duration to the operator for review.

Additionally or alternatively, the computer system can: input surface quality and a predicted environment exposure condition for each target area of the second structure into the paint failure prediction model and execute the paint failure prediction model to calculate a likelihood (e.g., a value, a percentage, a function) of paint failure in each target area prior to the target paint efficacy duration. Further, the computer system can: execute the paint failure prediction model to calculate a function characterizing possibility of each target area exhibiting paint failure prior to expiration of the target paint efficacy duration; apply a corresponding safety factor to the target paint efficacy duration defined by the user; and define an updated or revised target paint efficacy duration for the second structure.

For example, the computer system can: access a target paint efficacy duration, such as 10 years; execute the paint failure prediction model to calculate a likelihood of paint failure in each target area prior to expiration of the 10 years; derive a percentage of target areas likely to exhibit paint failure, such as 80%, based on a combination of likelihoods for each target area; apply a corresponding safety factor, such as 1.5, to the target paint efficacy duration defined by the user; and define an updated or revised target paint efficacy duration, such as 15 years, for the second structure. Thus, the computer system can derive an updated target paint efficacy duration to resolve target areas likely to exhibit paint failure rather than iteratively execute the paint failure prediction model over to converge on likelihood of paint failure in each target area less than a threshold likelihood.

Therefore, the computer system can automatically derive a target paint efficacy duration for each failure type of paint rather than interface with the user portal to receive selection of the target paint efficacy duration defined by a user associated with a structure. Additionally, the computer system can execute the paint failure prediction model to: calculate a likelihood of paint failure in each target area prior to the target paint efficacy duration; apply a safety factor to the target paint efficacy duration; and derive an updated target paint efficacy duration.

### 8.2 Single Output: Ambient Condition Ranges

In one variation, the computer system can execute Blocks of the method S100 to input the target paint efficacy duration, the known surface quality of each target area of the second structure, and a predicted environment exposure condition of each target area into the paint failure prediction model. The computer system can then execute the paint failure prediction model to calculate a set of ambient condition ranges corresponding to absence of predicted paint failure in each target area prior to expiration of the target paint efficacy duration.

In one example, the computer system receives a target paint efficacy duration, such as five years, specified for the second structure, such as a building. Then, for a first target area, in the constellation of target areas, of the building, the computer system: calculates a first ambient condition range representing values of ambient air temperatures of air proximal the first target area (e.g., between 65 degrees Fahrenheit and 68 degrees Fahrenheit) and corresponding to absence of predicted paint failure in the first target area prior to the five years; calculates a second ambient condition range representing values of ambient surface temperatures for the first target area (e.g., between 65 degrees Fahrenheit and 67 degrees Fahrenheit) and corresponding to absence of predicted paint failure in the first target area prior to the five years; and calculates a third ambient condition range representing values of ambient humidity of air proximal the first target area (e.g., between 45% humidity and 48% humidity) and corresponding to absence of predicted paint failure in the first target area prior to the five years. The computer system further: aggregates the first ambient condition range, the second ambient condition range, and the third ambient condition range into a first set of ambient condition ranges for the first target area; and associates the first set of ambient condition ranges with the first target area within the paint specification for the building.

The computer system can repeat these methods and techniques for each other target area in the constellation of target areas and for each other target surface of the structure in order to compile sets of ambient condition ranges into the paint specification for the structure.

In another example, the computer system: detects a set of features, representing surface characteristics, in a region of the composite image corresponding to a first target area of the second structure; derives a surface quality representing extant rust on the surface of the first target area; and generates a predicted environment exposure condition of the first target area following paint application onto the first target area, for the target paint efficacy duration. The computer system then: inputs the surface quality and the predicted environment exposure condition into the paint failure prediction model; and executes the paint failure prediction model to calculate a set of ambient condition ranges corresponding to absence of predicted paint failure for paint application over the extant rust in the first target area prior to the target paint efficacy duration.

Therefore, the computer system can execute the paint failure prediction model to: simulate predicted paint failure of each target area of the second structure; and converge on a set of ambient condition ranges to prevent paint failure on each target area prior to expiration of the target paint efficacy duration.

### 8.2.1 Range Breadth+Null Values+Revised Surface Qualities

In one implementation, the computer system executes Blocks of the method S100 to input a surface quality and a predicted environment exposure condition of each target area into the paint failure prediction model and to execute the paint failure prediction model to calculate a set of ambient condition ranges corresponding to absence of predicted failure in each target area prior to the target paint efficacy duration. Responsive to the set of ambient condition ranges exhibiting a range breadth—such as a span or width between a first value and a last value within an ambient condition range—exceeding a threshold breadth for a particular target area, the computer system associates the set of ambient condition ranges with the particular target area in the paint specification for the second structure, as shown in FIG. 3B.

Alternatively, responsive to the set of ambient condition ranges exhibiting a range breadth falling below a threshold breadth for a particular target area, the computer system: defines a revised surface quality in Block S174; and, based on the revised surface quality, predicted environment exposure condition, and the paint failure prediction model, calculates a new set of ambient condition ranges for this particular target area. Responsive to the new set of ambient condition ranges exceeding the threshold breadth, the computer system generates a prompt to prepare the particular target area according to the revised surface quality prior to paint application onto the particular target area.

For example, the computer system can: retrieve a surface quality of a target area in the constellation of target areas on the second structure; generate a predicted environment exposure condition of the target area following paint application onto the target area, for the target paint efficacy duration; input the surface quality and the predicted environment exposure condition of the target area into the paint failure prediction model; and execute the paint failure prediction model to calculate a set of ambient condition ranges corresponding to absence of predicted paint failure in the target area prior to the target paint efficacy duration. Then, in response to the set of ambient condition ranges exhibiting a range breadth falling below a threshold breadth, the computer system can: define a revised surface quality; input the revised surface quality and the predicted environment exposure condition into the paint failure prediction model; and execute the paint failure prediction model to calculate a new set of ambient condition ranges for this target area. Then, in response to the new set of ambient condition ranges exceeding the range breadth, the computer system: generates a prompt to prepare the target area according to the revised surface quality.

Similarly, responsive to the set of ambient condition ranges including null values (e.g., absence of values) representing absence of ambient conditions proximal the target area, the computer system can: define a revised surface quality for the target area; and, based on the revised surface quality, the predicted environment exposure condition, and the paint failure prediction model, calculate a new set of ambient condition ranges, as shown in FIG. 3B.

For example, the computer system can: retrieve a surface quality of a target area in the constellation of target areas on the second structure; generate a predicted environment exposure condition of the target area following paint application onto the target area, for the target paint efficacy duration; input the surface quality and the predicted environment exposure condition of the target area into the paint failure prediction model; and execute the paint failure prediction model to calculate a set of ambient condition ranges corresponding to absence of predicted paint failure in the target area prior to the target paint efficacy duration. Then, in response to the set of ambient condition ranges including null values representing absence of ambient conditions, proximal the target area (e.g., within a threshold distance of the target area), predicted to yield absence of predicted paint failure in the first target area prior to the target paint efficacy duration, the computer system can: define a revised surface quality; input the revised surface quality and the predicted environment exposure condition into the paint failure prediction model; and execute the paint failure prediction model to calculate a new set of ambient condition ranges for this target area. Then, in response to the new set of ambient condition ranges corresponding to absence of predicted paint failure in the target area prior to the target paint efficacy duration, the computer system can generate a prompt to prepare the target area according to the revised surface quality.

Therefore, the computer system can monitor a range breadth of the set of ambient condition ranges and/or values represented by the set of ambient condition ranges to a) compile sets of ambient conditions into a paint specification for the second structure or b) define a revised surface quality and a calculate a corresponding new set of ambient condition ranges for each target area on the second structure.

### 8.3 Output: Target Paint Thickness+Ambient Condition Ranges

Generally, the computer system can access paint thicknesses of paint on each painted area following paint application onto the painted area of the first structure from the paint map and generate the paint failure prediction model representing relationships between sets of paint attributes, paint thicknesses, and paint failure statuses of the constellation of painted areas on the first structure. The computer system can then execute Blocks of the method S100 to calculate a set of ambient condition ranges for each target area of the second structure.

More specifically, the computer system can access a set of paint attributes for each painted area of the first structure from the paint map including: a pre-paint surface quality of each painted area prior to paint application onto the painted area; an environment exposure condition of each painted area following paint application onto the painted area; and a set of ambient conditions, proximal the painted area, during application of paint onto each painted area from the paint map. The computer system can then implement methods and techniques described above to generate the paint failure prediction model representing relationships between pre-paint surface qualities, environment exposure conditions, sets of ambient conditions, paint thicknesses, and paint failure statuses of the constellation of painted areas on the first structure.

Furthermore, the computer system can: access a nominal paint thickness assigned to the second structure; input the surface quality of each target area of the second structure, and the predicted environment exposure condition of each target area, and the nominal paint thickness into the paint failure prediction model; and execute the paint failure prediction model to calculate a set of ambient condition ranges corresponding to absence of predicted paint failure in the first target area prior to the target paint efficacy duration. Responsive to the set of ambient condition ranges including null values representing absence of ambient conditions proximal the target area, the computer system can: calculate a paint thickness for the target area in Block S172; and, based on the surface quality, the paint thickness, the predicted environment exposure condition, and the paint failure prediction model, calculate a new set of ambient condition ranges. Then, responsive to the new set of ambient condition ranges corresponding to absence of predicted paint failure in the target area prior to target paint efficacy duration, the computer system can assign the target thickness to the target area.

For example, the computer system can: access a set of pre-paint application images captured by an optical sensor arranged in a paint system and depicting the second structure; extract a set of visual features representing surface characteristics of the second structure; derive a first surface quality of a first target area representing extant de-bonded paint (e.g., peeling paint from a target area) based on the set of visual features; access a nominal paint thickness, such as two coats of paint, assigned to the second structure; retrieve the target paint efficacy duration, such as ten years; input the first surface quality of the first target area, and the predicted environment exposure condition of the first target area, and the nominal paint thickness, such as two coats of paint, into the paint failure prediction model; and execute the paint failure prediction model to calculate a set of ambient condition ranges corresponding to absence of predicted paint failure in the first target area prior to the ten years. Then, in response to the set of ambient condition ranges including null values representing absence of ambient conditions proximal the first target area, the computer system can: calculate a paint thickness for the target area, such as three coats of paint; and, based on the surface quality, the paint thickness, the predicted environment exposure condition, and the paint failure prediction model, calculate a new set of ambient condition ranges. Then, responsive to the new set of ambient condition ranges corresponding to absence of predicted paint failure in the target area prior to the ten years, assign the target thickness to the first target area within the paint specification.

Therefore, the computer system can calculate a paint thickness for a target area associated with a set of ambient condition ranges representing null values rather than define a new surface quality. Additionally, the computer system can: input the target paint thickness, the surface quality, and the predicted environment exposure condition into the paint failure prediction model; and execute the paint failure prediction model to calculate a new set of ambient condition ranges and associate this new set of ambient condition ranges with the target area in the paint specification.

### 8.3.1 Output: Target Paint Thickness+Surface Preparation Instructions

In one variation, the computer system can execute Blocks of the method S100: to input the target paint efficacy duration, the known surface quality of a target area of the second structure, and a predicted environment exposure condition into the paint failure prediction model; and to calculate a surface preparation instruction for each target area of the second structure to reduce paint failure in each target area prior to expiration of the target paint efficacy duration. The computer system can assign the surface preparation instruction from a set of surface preparation instructions predefined by an operator or technician associated with the paint system. Alternatively, the computer system can receive a set of images annotated with a surface preparation instruction from the operator or technician prior to paint application onto the second structure. The computer system can then implement template matching techniques to assign a surface preparation instruction to each target area of the second structure.

In one implementation, the computer system can: access a first image annotated with a first surface preparation instruction specifying removal of extant paint or other extant materials by scraping; access a second image annotated with a second surface preparation instruction specifying sanding to smooth the texture of a target area; access a third image annotated with a third preparation instruction specifying abrasive blasting the surface of a target area; and/or access a fourth image annotated with fourth preparation instruction specifying water blasting or power washing the surface of a target area. The computer system can then input the target paint efficacy duration, the known surface quality of a target area of the second structure, a predicted environment exposure condition, and the set of surface preparation instructions into the paint failure prediction model. The computer system can execute the paint failure prediction model to calculate a target paint thickness of a first target area and then implement template matching techniques to assign a particular surface preparation instruction to the first target area.

In the foregoing example, the computer system can: access a set of surface preparation instructions for the second structure predefined by an operator of the paint system; assign a first surface preparation instruction to the first target area specifying removal of the extant de-bonded paint (e.g., peeling paint) by scraping based on the known surface quality and the set of surface preparation instructions; and associate the first surface preparation instruction and the first target paint thickness with the first target area within the paint specification for the second structure.

Therefore, the computer system can feed paint attributes of each target area and the target paint efficacy duration associated with the second structure into the paint failure prediction model to calculate a target paint thickness and a surface preparation instruction to reduce paint failure in each target area. The computer system can compile these target paint thicknesses and surface preparation instructions into a paint specification for paint application of the second structure.

### 8.3.2 Multiple Outputs

Additionally, the computer system can execute Blocks of the method S100 to input the target paint efficacy duration, the known surface quality of a target area of the second structure, a predicted environment exposure condition, and a set of surface preparation instructions into the paint failure prediction model. The computer system can then implement the methods and techniques described above to execute: the paint failure prediction model to calculate a set of ambient condition ranges, a target paint thickness; and a surface preparation instruction for each target area of the second structure, to reduce paint failure in each target area prior to expiration of the target paint efficacy duration.

Accordingly, the computer system can compile target paint thicknesses, surface preparation instructions, and sets of ambient condition ranges into the paint specification for the second structure. The computer system can then transmit the paint specification for the second structure to the controller of the paint system for execution, as further described below.

### 8.4 Example: Paint Failure Prediction Modeling Outputs for Second Structure

For example, the computer system can access the paint map of the first structure and extract paint attributes from the paint map including: a first surface quality of a surface of a first painted area of the first structure, such as of a low quality and rusty; a paint thickness of paint applied to the first painted area, such as two coats; an environment exposure condition of the first painted area, such as moderate; a surface temperature of the first painted area, such as 65 degrees Fahrenheit; an ambient temperature of air of the first painted area, such as 62 degrees Fahrenheit; and an ambient humidity of air of the first painted area, such as 45% humidity. The computer system can then: at a first time, receive a first set of post-paint application images from the controller corresponding to the completion of the paint application procedure; extract a first set of features from these images representing characteristics of the first painted area of the first structure; and, at approximately the first time based on the first set of features, detect a first defect of the paint, such as rust bleeding through the two coats of paint. Then, in response to detecting the first defect of the paint, the computer system can: generate a notification indicating the first defect on the first target surface of the first structure; and serve this notification to the user via an operator portal for inspection.

At approximately a second time, such as one day after completion of the paint application procedure, the computer system can: access a second set of post-paint application images captured by a camera accessed by the operator depicting a second painted area of the first structure and corresponding to a second paint thickness, such as five coats of paint; extract a second set of features from these images representing characteristics of the second painted area of the first structure; and, at approximately the second time and based on the second set of features, detect a second defect of the paint, such as sagging of the paint or running of the paint. Then, in response to detecting the second defect of the paint, the computer system can: generate a notification indicating the second defect on the second painted area of the first structure; and serve this notification to the user via the operator portal for inspection.

At approximately a third time, such as one week after completion of the paint application procedure, the computer system can: access a third set of post-paint application images captured by a camera accessed by the operator depicting a third painted area of the first structure and corresponding to a third paint thickness, such as 3 coats of paint; extract a third set of features from these images representing characteristics of the third painted area of the first structure; and, at approximately the third time based on the third set of features, detect a third defect of the paint, such as flaking of the paint. Then, in response to detecting the third defect of the paint, the computer system can: generate a notification indicating the third defect on the third painted area of the first structure; and serve this notification to the user via the operator portal for inspection.

At approximately a fourth time, such as one year after completion of the paint application procedure, the computer system can: access a fourth set of post-paint application images captured by a camera accessed by the operator depicting the first painted area, the second painted area, and the third painted area of the first structure; extract a fourth set of features from these images representing characteristics of the first structure; detect presence of the first defect, such as rust bleeding through the paint of the first painted area; detect presence of the third defect, such as paint de-bonded (e.g., paint flaking) from the third painted area; calculate a first elapsed duration from paint application onto the first structure to the current time of the first defect; and calculate a second elapsed duration from paint application onto the first structure to the current time of the third defect.

Furthermore, in response to the first elapsed duration of the first defect exceeding a threshold duration, such as three years, the computer system can: identify the first defect as a paint failure; detect a failure type, such as rust bleeding through paint, of the detected paint failure; and aggregate the elapsed duration from paint application and the failure type into a paint failure status for the first painted area. Similarly, in response to the second elapsed duration of the third defect exceeding a threshold duration, such as one year, the computer system can: identify the first defect as a paint failure; detect a failure type of the detected paint failure, such as paint flaking; and aggregate the elapsed duration from paint application and the failure type into a paint failure status for the third painted area of the first structure.

The computer system can generate a paint failure prediction model for the first painted area linking paint attributes and paint failure statuses. The computer system can implement methods and techniques described above: to segment a second structure into a constellation of target areas; to receive selection of a target paint efficacy duration for the second structure defined by the user; to access a surface quality of a first target area of a second structure; and to generate a predicted environment exposure condition, following paint application onto the first target area, for the target paint efficacy duration of the first target area. The computer system can then: input the surface quality and the predicted environment exposure condition of the first target area into the paint failure prediction model to calculate a set of ambient condition ranges corresponding to absence of predicted paint failure, (e.g., rust bleeding through the paint), in the first target area prior to expiration of the target paint efficacy duration.

Additionally or alternatively, the computer system can input the surface quality and the predicted environment exposure condition into the paint failure prediction model to calculate a set of ambient condition ranges corresponding to absence of predicted paint failure, (e.g., paint flaking) in the first target area prior to expiration of the target paint efficacy duration.

### 9. Paint Application+Second Structure

Generally, the computer system can transmit, to the controller, the paint specification for the second structure including: target paint thicknesses; surface preparation instructions; and ambient condition ranges. The controller can then implement methods and techniques described above for the first structure: to navigate the set of spray nozzles of the paint system across the second structure; and to apply paint to each target area of the second structure via the set of spray nozzles, as shown in FIG. 3C.

In one implementation, the controller can: trigger the work platform to navigate the spray nozzle across a first target area, in the constellation of target areas, on the second structure in Block S190; access a first set of ambient conditions proximal the first target area in Block S192; and, in response to the first set of ambient conditions falling within a first set of ambient condition ranges, spraying paint onto the first target area, in the constellation of target areas, via the spray nozzle in Block S194. Further, the controller can: trigger the work platform to navigate the spray nozzle across a second target area in the constellation of target areas; detect a second ambient air temperature of air proximal the second target area, in the constellation of target areas, on the second structure; detect a second surface temperature of the second target area, in the constellation of target areas; and, in response to the second ambient air temperature falling outside of a second set of ambient condition ranges, and in response to the second surface temperature falling outside of the second set of ambient condition ranges, deactivate the spray nozzle to prevent paint application onto the second target area in the constellation of target areas.

### 9.1 In-Process Paint Application: Ambient Conditions

In one variation, the controller can receive the paint specification from the computer system and implement methods and techniques described above to capture an image of each target area prior to paint application via the optical sensor. The controller can further detect ambient conditions of air proximal each target area (e.g., within a threshold distance of each target area) of the second structure. Responsive to ambient conditions falling within a corresponding target range defined in the paint specification, the controller can navigate the set of spray nozzles and apply paint to the particular target area of the second structure.

For example, the controller can: receive the paint specification from the computer system; detect an ambient air temperature of air, such as 65 degrees Fahrenheit, proximal a first target area, in the constellation of target areas, on the second structure; detect a surface temperature, such as 60 degrees Fahrenheit, of the first target area; and detect an ambient humidity of air proximal the first target area, such as 50% humidity. The controller can then trigger the spray nozzle to spray paint onto the first target area, in the constellation of target areas: in response to the ambient air temperature falling within a first target range, such as between 63 degrees and 68 degrees Fahrenheit; in response to the surface temperature falling outside of a second target range, such as between 59 degrees Fahrenheit and 62 degrees Fahrenheit; and in response to the ambient humidity falling within a third target range, such as between 45% humidity and 55% humidity.

Alternatively, responsive to ambient conditions falling outside of a corresponding target range defined in the paint specification, the controller can automatically terminate paint application onto the target area or generate a notification for an operator of the paint system to terminate paint application onto the first target area of the second structure.

For example, the controller can: receive the paint specification from the computer system; detect an ambient air temperature of air proximal a first target area, in the constellation of target areas of the second structure, such as 60 degrees Fahrenheit; detect a surface temperature of the first target area, in the constellation of target areas of the second structure, such as 58 degrees Fahrenheit; and deactivate the spray nozzle to prevent paint application onto the first target area in the constellation of target areas defined in the paint specification in response to the ambient air temperature falling outside of a first target range, such as between 63 degrees and 68 degrees Fahrenheit, and in response to the surface temperature falling outside of a second target range, such as between 59 degrees Fahrenheit and 62 degrees Fahrenheit.

### 9.2 Second Structure Paint Map

Generally, the computer system (or the controller) can implement the methods and techniques described above to generate a paint map for the second structure.

For example, during a first paint application cycle, the controller can: trigger the work platform to navigate the spray nozzle across a first target area, in the constellation of target areas, on the second structure; access a first set of ambient conditions proximal the first target area; in response to the first set of ambient conditions falling within a first set of ambient condition ranges, trigger the set of spray nozzles to spray paint onto the first target area, in the constellation of target areas; and access a first image depicting paint applied onto the first target area and captured by the optical sensor.

During a second paint application cycle, the controller can: trigger the work platform to navigate the spray nozzle across a second target area in the constellation of target areas; detect, on the second structure, a second ambient air temperature of air proximal the second target area, in the constellation of target areas; detect, in the constellation of target areas, a second surface temperature of the second target area; in response to the second set of ambient conditions falling within a second set of ambient condition ranges, trigger the set of spray nozzles to spray paint onto the second target area; and access a second image depicting paint applied onto the second target area and captured by the optical sensor. The computer system can then combine the first image and the second image into a composite image representing application of paint onto the first target area and the second target area on the second structure in Block S198. The computer system can further annotate the composite image with corresponding ambient conditions from each paint application cycle.

The computer system can repeat these methods and techniques for each other target area, for each other image, and for each other set of ambient conditions to generate a paint map for the second structure.

### 9.3 Duration to Predicted Paint Failure+Paint Map

In one variation, the controller can receive the paint failure prediction model from the computer system and execute the paint failure prediction model to calculate a duration to predicted paint failure for each target area prior to paint application onto the second structure, such as a quantity of months or a quantity of years.

For example, the controller can: receive selection of a minimum paint efficacy duration specified for the second structure and defined by a user within the user portal, such as two years; and receive the paint failure prediction model from the computer system. The controller can then: trigger the work platform to navigate the spray nozzle across a first target area, in the constellation of target areas, on the second structure; detect a first ambient air temperature of air proximal the first target area, in the constellation of target areas, on the second structure; detect a first surface temperature of the first target area; insert the first ambient air temperature, the first surface temperature, and a first predicted environment exposure condition of the first target area into the paint failure prediction model; and execute the paint failure prediction model to calculate a duration to predicted paint failure for the first target area, such as three years. The computer system can then, in response to the first set of ambient conditions falling within the first set of ambient condition ranges and in response to the duration to predicted paint failure exceeding the minimum paint efficacy duration, trigger the set of spray nozzles to spray paint onto the first target area.

The computer system can repeat these methods and techniques for each other target area in the constellation of target areas and annotate the paint map of the second structure with these durations to predicted paint failure.

### 10. Live Process Report+Second Structure

In one variation, the computer system: implements methods and techniques described above to annotate the paint map (e.g., the second structure model) with regions of the second structure completed by the system based on color images, depth maps, and/or spray nozzle position data captured by the system; highlights regions of the second structure completed by the system; and presents the paint map—with highlighted regions—to the operator and/or a user associated with the second structure.

Additionally or alternatively, the computer system can: calculate a proportion (or ratio) of paint application on the second structure completed by the system; and present this proportion to the operator and/or the second structure associate.

Additionally or alternatively, the computer system can: predict a time to completion at which the system will complete application of paint on the whole second structure, such as based on the remaining target area of the second structure and the current raster speed of the set of spray nozzles; and present this time to completion to the operator and/or the second structure associate.

Furthermore, the computer system can present the paint map—such as the pre- and post-paint application layers of the paint map—to the second structure associate, thereby enabling the second structure associate to immediately and remotely review and inspect the condition of the second structure prior to application of paint and after application of paint.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for detecting degradation of paint comprising:
during a first time period:
segmenting a first structure into a constellation of painted areas;
for each painted area in the constellation of painted areas:
accessing a set of paint attributes of the painted area comprising:
a pre-paint surface quality of the painted area prior to paint application onto the painted area;
an environment exposure condition of the painted area following paint application onto the painted area; and
a set of ambient conditions, proximal the painted area, during paint application onto the painted area; and
accessing a paint failure status of the painted area, the paint failure status representing:
one of presence and absence of a detected paint failure in the painted area; and
responsive to presence of the detected paint failure in the painted area, an elapsed duration from paint application onto the painted area to occurrence of the detected paint failure in the painted area; and
generating a paint failure prediction model representing relationships between sets of paint attributes and paint failure statuses of the constellation of painted areas on the first structure; and
during a second time period:
segmenting a second structure into a constellation of target areas;
accessing a target paint efficacy duration for the second structure;
for each target area in the constellation of target areas:
retrieving a surface quality of the target area;
generating a predicted environment exposure condition of the target area, following paint application onto the target area, for the target paint efficacy duration; and
based on the paint failure prediction model, the surface quality of the target area, and the predicted environment exposure condition of the target area, calculating a set of ambient condition ranges corresponding to absence of predicted paint failure in the target area prior to the target paint efficacy duration; and
compiling sets of ambient condition ranges for the constellation of target areas into a paint specification for the second structure.

2. The method of claim 1:
wherein retrieving the surface quality of the target area for each target area in the constellation of target areas comprises, for a first target area in the constellation of target areas:
retrieving a first surface quality of the first target area;
wherein generating the predicted environment exposure condition of the target area for each target area in the constellation of target areas comprises, for the first target area:
generating a first predicted environment exposure condition of the first target area following paint application onto the first target area, for the target paint efficacy duration;
wherein calculating the set of ambient condition ranges for each target area in the constellation of target areas comprises, for the first target area:
based on the paint failure prediction model, the first surface quality of the first target area, and the first predicted environment exposure condition of the first target area, calculating a first set of ambient condition ranges corresponding to absence of predicted paint failure in the first target area prior to the target paint efficacy duration; and
further comprising, during the second time period:
in response to the first set of ambient condition ranges exhibiting a first range breadth falling below a threshold breadth:
defining a revised surface quality of the first target area; and
based on the paint failure prediction model, the revised surface quality of the first target area, and the first predicted environment exposure condition of the first target area, calculating a second set of ambient condition ranges corresponding to absence of predicted paint failure in the first target area prior to the target paint efficacy duration; and
in response to the second set of ambient condition ranges exhibiting a second range breadth exceeding the threshold breadth, generating a prompt to prepare the first target area according to the revised surface quality.

3. The method of claim 2, further comprising, during the second time period:
in response to the first set of ambient condition ranges comprising null values representing absence of ambient conditions, proximal the first target area, predicted to yield absence of predicted paint failure in the first target area prior to the target paint efficacy duration:
defining a revised surface quality of the first target area; and
based on the paint failure prediction model, the revised surface quality of the target area, and the first predicted environment exposure condition of the target area, calculating a second set of ambient condition ranges corresponding to absence of predicted paint failure in the first target area prior to the target paint efficacy duration; and
in response to the second set of ambient condition ranges corresponding to absence of predicted paint failure in the first target area prior to the target paint efficacy duration, generating a prompt to prepare the first target area according to the revised surface quality.

4. The method of claim 1:
wherein compiling sets of ambient condition ranges into the paint specification comprises compiling sets of ambient condition ranges into the paint specification for the second structure for execution by a paint system comprising:
a work platform;
a spray nozzle arranged on the work platform; and
an optical sensor arranged on the work platform and adjacent the spray nozzle; and
further comprising, during a third time period, at the paint system:
triggering the work platform to navigate the spray nozzle across a first target area, in the constellation of target areas, on the second structure;
accessing a first set of ambient conditions proximal the first target area; and
in response to the first set of ambient conditions falling within a first set of ambient condition ranges, spraying paint onto the first target area, in the constellation of target areas, via the spray nozzle.

5. The method of claim 4:
wherein accessing the first set of ambient conditions proximal the first target area comprises:
detecting a first ambient air temperature of air proximal the first target area, in the constellation of target areas, on the second structure; and
detecting a first surface temperature of the first target area, in the constellation of target areas, of the second structure; and
wherein spraying paint onto the first target area comprises spraying paint onto the first target area:
in response to the first ambient air temperature falling within the first set of ambient condition ranges; and
in response to the first surface temperature falling within the first set of ambient condition ranges.

6. The method of claim 4, further comprising:
triggering the work platform to navigate the spray nozzle across a second target area in the constellation of target areas;
detecting a second ambient air temperature of air proximal the second target area, in the constellation of target areas, on the second structure;
detecting a second surface temperature of the second target area, in the constellation of target areas; and
deactivating the spray nozzle to prevent paint application onto the second target area in the constellation of target areas:
in response to the second ambient air temperature falling outside of a second set of ambient condition ranges; and
in response to the second surface temperature falling outside of the second set of ambient condition ranges.

7. The method of claim 4:
wherein accessing the target paint efficacy duration for the second structure comprises receiving selection of the target paint efficacy duration, comprising a minimum paint efficacy duration, for the second structure and defined by a user;
wherein accessing the first set of ambient conditions proximal the first target area comprises:
detecting a first ambient air temperature of air proximal the first target area, in the constellation of target areas, on the second structure; and
detecting a first surface temperature of the first target area in the constellation of target areas; and
further comprising, during the third time period:
inserting the first ambient air temperature, the first surface temperature, and a first predicted environment exposure condition of the first target area into the paint failure prediction model; and
executing the paint failure prediction model to calculate a duration to predicted paint failure for the first target area; and
wherein spraying paint onto the first target area, in the constellation of target areas, via the spray nozzle comprises spraying paint onto the first target area via the spray nozzle:
in response to the first set of ambient conditions falling within the first set of ambient condition ranges; and
in response to the duration to predicted paint failure exceeding the minimum paint efficacy duration.

8. The method of claim 4, further comprising:
accessing a first image depicting paint applied onto the first target area and captured by the optical sensor;
triggering the work platform to navigate the spray nozzle across a second target area above the first target area;
accessing a second set of ambient conditions proximal the second target area;
in response to the second set of ambient conditions falling within a second set of ambient condition ranges, spraying paint onto the second target area, in the constellation of target areas, via the spray nozzle;
accessing a second image depicting paint applied onto the second target area and captured by the optical sensor; and
combining the first image and the second image into a composite image representing application of paint onto the first target area and the second target area on the second structure.

9. The method of claim 1:
further comprising, during the second time period:
accessing a set of images depicting the second structure;
compiling a subset of images, in the set of images, into a composite image depicting a contiguous target surface of the second structure;
detecting a boundary of the contiguous target surface in the composite image;
scaling a grid array of rectilinear areas to yield target area dimensions on the contiguous target surface; and
projecting the grid array of rectilinear areas onto the composite image within the boundary to define the constellation of target areas on the second structure; and
wherein retrieving the surface quality of the target area for each target area in the constellation of target areas comprises, for each target area in the constellation of target areas:
detecting a set of features in a region of the composite image corresponding to the target area; and
deriving the surface quality of the target area based on the set of features.

10. The method of claim 9:
wherein retrieving the surface quality of the target area for each target area in the constellation of target areas comprises, for a first target area in the constellation of target areas:
detecting a first set of features, representing surface characteristics, in a first region of the composite image corresponding to the first target area; and
deriving a first surface quality representing extant rust on the surface of the first target area;
wherein generating the predicted environment exposure condition of the target area for each target area in the constellation of target areas comprises, for the first target area:
generating a first predicted environment exposure condition of the first target area following paint application onto the first target area, for the target paint efficacy duration; and
wherein calculating the set of ambient condition ranges for each target area in the constellation of target areas comprises, for the first target area:
based on the paint failure prediction model, the first surface quality of the first target area, and the first predicted environment exposure condition of the first target area, calculating a first set of ambient condition ranges corresponding to absence of predicted paint failure for paint application over the extant rust in the first target area prior to the target paint efficacy duration.

11. The method of claim 1:
wherein calculating the set of ambient condition ranges corresponding to absence of predicted paint failure in the target area prior to the target paint efficacy duration for each target area in the constellation of target areas comprises, for a first target area in the constellation of target areas:
based on the paint failure prediction model, a first surface quality of the first target area, and the predicted environment exposure condition of the first target area:
calculating a first ambient condition range, representing values of ambient air temperatures of air proximal the first target area, corresponding to absence of predicted paint failure in the first target area prior to the target paint efficacy duration;
calculating a second ambient condition range, representing values of ambient surface temperatures for the first target area, corresponding to absence of predicted paint failure in the first target area prior to the target paint efficacy duration; and
calculating a third ambient condition range, representing values of ambient humidity of air proximal the first target area, corresponding to absence of predicted paint failure in the target area prior to the target paint efficacy duration; and
further comprising, during the second time period, aggregating the first ambient condition range, the second ambient condition range, and the third ambient condition range into a first set of ambient condition ranges for the first target area.

12. The method of claim 1:
further comprising, during the first time period, for each painted area in the constellation of painted areas, accessing a location and an orientation of the painted area;
wherein accessing the target paint efficacy duration for the second structure comprises receiving selection of a first time window for paint application onto the second structure; and
wherein accessing the predicted environment exposure condition of the target area for each target area in the constellation of target areas comprises, for a first target area in the constellation of target areas:
based on locations and orientations of the constellation of painted areas and historical weather conditions for time windows analogous to the first time window, accessing a set of weather conditions within the first time window for the first target area; and
based on the set of weather conditions, generating a predicted environment exposure condition for the first target area.

13. The method of claim 1:
further comprising, during the first time period, for each painted area in the constellation of painted areas:
accessing a paint thickness of paint on the painted area following paint application onto the painted area;
wherein generating the paint failure prediction model comprises generating the paint failure prediction model representing relationships between sets of paint attributes, paint thicknesses, and paint failure statuses of the constellation of painted areas on the first structure;
further comprising, during the second time period, accessing a nominal paint thickness assigned to the second structure;
wherein retrieving the surface quality of the target area for each target area in the constellation of target areas comprises, for a first target area in the constellation of target areas:
retrieving a first surface quality of the first target area;
wherein generating the predicted environment exposure condition of the target area for each target area in the constellation of target areas comprises, for the first target area:
generating a first predicted environment exposure condition of the first target area following paint application onto the first target area, for the target paint efficacy duration; and
wherein calculating the set of ambient condition ranges for each target area in the constellation of target areas comprises, for the first target area:
based on the paint failure prediction model, the nominal paint thickness assigned to the second structure, the first surface quality of the first target area, and the first predicted environment exposure condition of the first target area, calculating a first set of ambient condition ranges corresponding to absence of predicted paint failure in the first target area prior to the target paint efficacy duration.

14. The method of claim 13, further comprising, during the second time period:
in response to the first set of ambient condition ranges comprising null values representing absence of ambient conditions proximal the target area predicted to yield absence of predicted paint failure in the first target area prior to the target paint efficacy duration:
calculating a first paint thickness, greater than the nominal paint thickness for the first target area; and
based on the paint failure prediction model, the first surface quality of the first target area, the first predicted environment exposure condition of the target area, and the first paint thickness, calculating a second set of ambient condition ranges corresponding to absence of predicted paint failure in the first target area prior to the target paint efficacy duration; and
in response to the second set of ambient condition ranges corresponding to absence of predicted paint failure in the first target area prior to the target paint efficacy duration, assigning the first paint thickness to the first target area.

15. The method of claim 1:
wherein calculating the set of ambient condition ranges for each target area in the constellation of target areas comprises, for each target area, in the constellation of target areas:
based on the paint failure prediction model, the surface quality of the target area, and the predicted environment exposure condition of the target area, calculating the set of ambient condition ranges corresponding to likelihood of paint failure in the target area prior to the target paint efficacy duration.

16. A method for detecting degradation of paint comprising:
during a first time period:
segmenting a first structure into a constellation of painted areas;
for each painted area in the constellation of painted areas:
accessing a set of paint attributes of the painted area and comprising:
a pre-paint surface quality of the painted area prior to paint application onto the painted area;
an environment exposure condition of the painted area following paint application onto the painted area; and
a set of ambient conditions, proximal the painted area, during application of paint onto the painted area; and
accessing a paint failure status of the painted area, the paint failure status representing:
one of presence and absence of a detected paint failure in the painted area; and
responsive to presence of the detected paint failure in the painted area, an elapsed duration from paint application onto the painted area to occurrence of the detected paint failure in the painted area; and
generating a paint failure prediction model representing relationships between sets of paint attributes and paint failure statuses of the constellation of painted areas on the first structure; and
during a second time period:
segmenting a second structure into a constellation of target areas;
accessing a target paint efficacy duration for the second structure;
for each target area in the constellation of target areas:
retrieving a surface quality of the target area;
generating a predicted environment exposure condition of the target area, following paint application onto the target area, for the target paint efficacy duration; and
based on the paint failure prediction model, the surface quality of the target area, and the predicted environment exposure condition of the target area, calculating a set of ambient condition ranges corresponding to likelihood of paint failure in the target area prior to the target paint efficacy duration; and
compiling sets of ambient condition ranges for the constellation of target areas into a paint specification for the second structure.

17. The method of claim 16:
wherein retrieving the surface quality of the target area for each target area in the constellation of target areas comprises, for a first target area in the constellation of target areas:
retrieving a first surface quality of the first target area;
wherein generating the predicted environment exposure condition of the target area for each target area in the constellation of target areas comprises, for the first target area:
generating a first predicted environment exposure condition of the first target area following paint application onto the first target area, for the target paint efficacy duration;
wherein calculating the set of ambient condition ranges for each target area in the constellation of target areas comprises, for the first target area:
based on the paint failure prediction model, the first surface quality of the first target area, and the first predicted environment exposure condition of the first target area, calculating a first set of ambient condition ranges corresponding to absence of predicted paint failure in the first target area prior to the target paint efficacy duration; and
wherein compiling sets of ambient condition ranges into the paint specification comprises compiling the first set of ambient condition ranges into the paint specification for the first target area on the second structure.

18. A method for detecting degradation of paint comprising:
during a first time period:
segmenting a first structure into a constellation of painted areas;
for each painted area in the constellation of painted areas:
accessing a first set of paint attributes for the painted area;
accessing a paint thickness of the painted area following paint application onto the painted area; and
accessing a paint failure status of the painted area following paint application onto the painted area; and
generating a paint failure prediction model representing relationships between sets of paint attributes, paint thicknesses, and paint failure statuses for the constellation of painted areas on the first structure; and
during a second time period:
segmenting a second structure into a constellation of target areas;
accessing a target paint efficacy duration for the second structure;
for each target area in the constellation of target areas:
accessing a second set of paint attributes of the target area; and
based on the paint failure prediction model and the second set of paint attributes of the target area, calculating a target paint thickness corresponding to absence of predicted paint failure in the target area prior to the target paint efficacy duration; and
compiling target paint thicknesses into a paint specification for the second structure.

19. The method of claim 18:
wherein accessing the set of paint attributes for each painted area in the constellation of painted areas comprises, for each painted area in the constellation of painted areas, accessing the set of paint attributes for the painted area and comprising:
a pre-paint surface quality of the painted area prior to paint application onto the painted area;
an environment exposure condition of the painted area following paint application onto the painted area; and
a set of ambient conditions, proximal the painted area, during application of paint onto the painted area; and
wherein generating the paint failure prediction model comprises generating the paint failure prediction model representing relationships between pre-paint surface qualities, environment exposure conditions, sets of ambient conditions, paint thicknesses, and paint failure statuses of the constellation of painted areas on the first structure.

20. The method of claim 19:
wherein accessing the second set of paint attributes for each target area in the constellation of target areas comprises, for a first target area in the constellation of target areas:
accessing a first surface quality of the first target area; and
generating a first predicted environment exposure condition of the first target area following paint application onto the first target area, for the target paint efficacy duration; and
wherein calculating the target paint thickness corresponding to absence of predicted paint failure for each target area in the constellation of target areas comprises, for the first target area:
based on the paint failure prediction model, the first surface quality of the first target area, and the first predicted environment exposure condition of the first target area, calculating a first target paint thickness corresponding to absence of predicted paint failure in the target area prior to target paint efficacy duration.
